(19) United States
(12) Patent Application Publication
(10) Pub. No.: US 2014/0050906 A1
(43) Pub. Date: Feb. 20, 2014

(54) INJECTION MOLDED PANEL, A MOLD AND A METHOD FOR ITS MANUFACTURE

(71) Applicant: Efraim Haimoff, Mevasereth Zion (IL)

(72) Inventor: Efraim Haimoff, Mevasereth Zion (IL)

(73) Assignee: KETER PLASTIC LTD., Herzelyia (IL)

(21) Appl. No.: 14/002,458

(22) PCT Filed: Mar. 1, 2012
(86) PCT No.: PCT/IL12/50066

§ 371 Date: Nov. 8, 2013

Related U.S. Application Data
(60) Provisional application No. 61/447,852, filed on Mar. 1, 2011.

(51) Int. Cl. B29C 45/00; B29C 33/00

(52) U.S. Cl. CPC B29C 45/0025; B29C 33/00
USPC 428/213; 425/555; 264/328.1

(57) ABSTRACT

Provided is an injection molded panel, a mold for forming the panel, and its method of manufacture. The panel is configured with a front surface and a back surface, the back surface being configured with one or more ribs integrally extending from the back surface via a transition wall portion. The transition wall portion in accordance with the disclosed subject matter is significantly thinner than the rib and/or the panel.

### FIELD OF THE INVENTION

The present disclosed subject matter is directed to molded panels and in particular to such panels substantially devoid of sink marks. The disclosed subject matter is further concerned with a method for manufacturing such panels and further to a mold for manufacturing such panels.

### BACKGROUND OF THE INVENTION

Various plastic articles are formed with reinforcing support structures providing strength to the plastic article or extensions for assisting mounting a molded plastic article to an underlying structure, or to secure items to the inside of a molded plastic article. For these and other purposes the back surface of the molded plastic article typically has molded extensions, e.g., molded mounting extensions such as posts, ribs and bosses, extending therefrom. For example, the molded article can be mounted on an underlying frame by means of fasteners, such as screws, passing through the frame and into the molded mounting extensions.

In many applications and industries in which molded plastic articles are used, it is desirable to reduce weight without compromising the structural integrity of the molded plastic article. Typically, the weight of a molded plastic article is reduced by making it thinner. To maintain the same level of dimensional stability and structural integrity relative to a thicker molded article, thinner molded articles are typically designed to include structural supports (e.g., ribs) extending from the non-cosmetic rear surface thereof.

Extensions, such as structural and/or mounting supports, extending from the rear surface of a molded plastic article are often undesirably accompanied by defects, such as sink marks in the outer or cosmetic front surface of the molded article, or warping defects throughout at least a portion of the molded article. Sink mark defects are typically located on the front surface opposite of the extension. The defects are generally undesirable because of an accompanying reduction in cosmetic appearance (e.g., in the case of sink marks), and structural integrity (e.g., in the case of warping defects).

U.S. Pat. No. 4,339,408 discloses a method of molding a hollow, plastic article having ribs extending from its walls comprising the steps of positioning the mold cavity forming members in a closed position to define a mold cavity corresponding to the configuration of the article; injecting molten thermoplastic material into the cavity; allowing the material to cool for a predetermined period of time to permit partial cooling and setting of the plastic; injecting additional plastic material into the rib forming portion of the mold cavity at a plurality of injection points spaced along the rib portion; pausing for a second predetermined time to permit complete setting of the plastic in the mold; displacing the cavity defining members from their closed position and exerting an ejecting pressure on the rib portion at the plurality of injection points along its length to aid in ejecting the article from the mold.

U.S. Pat. No. 6,551,540 discloses a method, molding device and vehicle component that provide for minimized sink marks caused by structural ribs in the molding process. Molten material is injected into a first mold cavity to form a primary vehicle component part having structural ribs on a back side. Typically, sink marks can develop at a front surface of the primary vehicle component part, located opposite to the structural ribs on the back side. Molten material is injected into a second molding cavity that is arranged to overmold the front surface of the primary vehicle component part and to cover sink marks, if any, in the front surface. In this manner, a vehicle component is manufactured with structural ribs and without visible sink marks.

U.S. 2002/0172803 discloses a method of forming a molded article having at least one compression molded plastic layer and at least one plastic projection extending from and bonded to the inner surface of the compression molded plastic layer. The method of US Application '803 involves first forming a plastic layer by compression molding, allowing the compression molded plastic layer to cool, and then forming plastic projections on the back surface of the compression molded plastic layer by injection molding methods.

U.S.2008057285 discloses a method of forming a molded plastic article having a second surface with molded extension, e.g., structural supports, such as ribs, extending therefrom, and a first surface that is substantially free of sink mark defects. The method involves forming, from a first plastic material, a first molded section having at least one molded extension extending from the second surface thereof. The molded extension is formed in a mold recess having a reversibly positionable slide therein. After formation of the first molded section, the slide is retracted to a second slide position thus forming within the molded extension a retainer cavity that is in fluid communication with an aperture in the first surface of the first molded section. A second plastic material is introduced into the mold over the first molded section, and a portion thereof passes through the aperture and into the retainer cavity, thereby forming a second molded section that is continuous with each retainer. The first and second molded sections, which together form the molded article, are fixedly attached to each other by at least one molded retainer, and the first surface of the second molded section, which defines the first surface of the molded article, is substantially free of sink mark defects. The present invention also relates to a molded article.

### SUMMARY OF THE INVENTION

It is one object of the present disclosed subject matter to provide injection molded panels substantially free of sink marks or significantly not noticeable (i.e. not visible to the eye).

The term sink mark denotes a local surface depression (a shallow linear depression, or a dimple) that typically occurs in moldings with thicker sections, or at locations above ribs, bosses, and internal fillets, due to collapsing of the surface following local internal shrinkage after the molding process.

Sink marks are caused by localized shrinkage of the molded material at thick sections without sufficient compensation when the part is cooling. Sink marks often occur in extrusion on a surface that is opposite to and adjoining a leg or rib. Factors influencing sink marks are for example low injection pressure, short hold time or cooling time, high melt temperature or mold temperature, local geometric features (design), etc.

Sink marks occur for example after the material on the outside surface of an injected molded element has cooled and solidified, whilst the core material starts to cool. Its shrinkage pulls the surface of the main wall inward, causing a sink mark thereon.

According to a first aspect of the disclosed subject matter there is provided an injection molded panel element configured with a front surface and a corresponding back surface, wherein the back surface is configured with one or more ribs integrally molded therewith and extending therefrom, said ribs extending from the back surface via a transition wall portion significantly thinner than the rib thickness.

According to another aspect the of the disclosed subject matter there is provided an injection molded panel element configured with a front surface and a corresponding back surface, wherein the back surface is configured with one or more ribs integrally molded therewith and extending therefrom via a transition wall portion, wherein the area of the contact surface between the transition wall portion is significantly smaller than the cross sectional area of the rib below the transition wall portion.

According to another aspect the of the disclosed subject matter there is provided an injection molded panel element configured with a front surface and a corresponding back surface, wherein the back surface is configured with one or more ribs integrally molded therewith and extending therefrom, said ribs extending from the back surface via a transition wall portion, wherein the width of the contact area between the transition wall portion and the panel is significantly thinner than the thickness of either the panel or the rib.

An injection molded panel configured with a front surface and a corresponding back surface, wherein the back surface is configured with one or more ribs integrally molded therewith and extending therefrom, said ribs extending from the back surface via a transition wall portion, wherein the transition wall portion is a non continuous, undulating structure of elements, and wherein the thickness of the transition wall portion is the same as the thickness of the rib and wherein the width of the contact surface of each undulating element associated with the panel is significantly smaller than the thickness of the panel and/or is smaller than the thickness of the rib.

The term back surface as used herein in the specification and claims denotes a surface of the injection molded article configured with an integrally molded rib extending from said surface.

The term front surface as used herein in the specification and claims denotes a surface opposite the back surface of the injection molded article, in correspondence with the rib, and substantially devoid of, or not noticeable to the eye, sink marks opposite the rib.

The term rib as used herein in the specification and claims denotes a wall portion integrally molded and extending from the back surface at any orientation. The rib can have any geometrical configuration, such as a planar configuration, annular(e.g. ring like configuration, hexagonal etc.) etc. The rib can be a continuous structure or a non continuous structure. The rib in accordance with the presently disclosed subject matter can be configured for assisting mounting a molded plastic article to another structure.

It is thus appreciated that the terms back surface and front surface are relative, i.e. associated with the surface bearing a rib (back surface) and the opposite surface (front surface), respectively, and not necessarily associated with front or rear face of an element.

The term transition wall portion as used herein in the specification and claims denotes a wall portion constituting an integral part of the rib. The transition wall portion can be an integral part of the rib, having substantially the same thickness or can be significantly thinner therefrom. The transition wall portion can be a unitary continuous structure or can have a non continuous structure, e.g. undulating and/or zigzagged configuration of geometrical shapes such as taper conical, spherical, circular, triangular bodies etc.

It will be appreciated that the phrase “significantly thinner” or “significantly smaller” refers to about 1-20% relative the thickness of the associated feature, e.g. panel, rib etc. In accordance with an example it refers to 8-12%. In accordance with yet and example it refers to 10%. For example, where indication is made that X is significantly thinner than Y, it will be appreciated that this indicates that the thickness (or size in diameter) of X is anywhere in the range of 1-20% of the thickness of Y.

In accordance with an embodiment of the presently disclosed subject matter the thickness of the rib is equal to or less than the thickness of the panel. In accordance with another embodiment the thickness of the rib is bigger than the thickness of the panel.

In accordance with yet an embodiment, the thickness of the transition wall portion is about the thickness of the rib. In accordance with this embodiment, the transition wall portion is non continuous, having an undulating configuration of geometrical bodies, such that the dimensions of contact between the transition wall portions and the panel are significantly thinner that the thickness of the panel.

According to another aspect of the present disclosed subject matter there is provided a mold for injection molding of a panel, the mold configured with a sliding ruler displaceable about a plane and configured with a rib defining wall surface having a pointed ridge; said ruler displaceable about a plane between a closed position in which the rib defining wall bears in close proximity with an opposite rib wall of the mold and defining together a rib thickness space, and an open position in which the ruler is spaced apart from the opposite rib wall, wherein at the closed position said pointed ridge extends closer to said opposite rib wall than the rib thickness.

According to a further aspect of the present disclosed subject matter there is provided a method for molding a panel configured with a front surface and a back surface, said back surface is configured with one or more ribs integrally extending from said back surface via a transition wall portion significantly thinner than the rib thickness, the method comprising the following steps:
(a) Obtaining a mold configured with a sliding ruler displaceable about a plane of the back surface and configured with a rib defining wall surface having a pointed ridge;
(b) Placing the mold over a molding table;
(c) Displacing the ruler into a closed position in which the rib defining wall bears in close proximity with an opposite rib wall of the mold and defining together a rib thickness space, wherein said pointed ridge extends closer to said opposite rib wall than the rib thickness;
(d) Applying a molten material into the mold at substantially constant pressure and velocity;
(e) Allowing the molded panel to cool;
(f) Displacing the ruler into an open position in which the ruler is spaced apart from the opposite rib wall
(g) Removing the molded panel.

Where core injection is involved, the method further comprises before step c) injection cores are displaced into a closed position at a direction transversing the displacement of the rulers and after step e) said injection cores are displaced into their respective open position.

Any one or more of the following features, qualities and designs can be applied, independently or jointly, and applied respectively to any of the aspects of the present disclosed aspects of the presently disclosed subject matter:
The rib can be a support rib configured for rigidifying the panel;
Ribs can extend at either or both the front surface and the back surface of the panel;
A rib can extend at a right angle with respect to the surface or inclined with respect thereto (as an undercut);
The rib can extend longitudinally and/or transversely, at a right angle or inclined with respect to a longitudinal axis;
The transition wall portion can tapper;
The transition wall portion can be a continuous portion or a non continuous portion;
The rib can be attached to the back surface of the panel through intermittent transition wall portions, e.g. spherical bead like structures, having a point of contact with the back surface of significantly smaller dimensions than the thickness of the panel;
The transition wall portion can have a spherical or semi spherical configuration such that the point of contact between the back surface of the panel and the spherical or semi spherical body is of dimensions significantly smaller than the thickness of the panel;
The transition wall in the form of a spherical or semi spherical configuration can have a diameter significantly smaller than the thickness of the panel;
The transition wall portion can have a circular or semi circular configuration such that the point of contact between the back surface of the panel and the circular or semi circular body is significantly smaller than the thickness of the panel;
The transition wall portion can have a triangular configuration such that the point of contact between the back surface of the panel and the apex of the triangular body is significantly smaller than the thickness of the panel;
The transition wall portion configured as the spherical, semi spherical or triangular bodies can further comprise a film of plastic material connecting the to bodies so as to prevent openings between the bodies. It will be appreciated that the film is thinner than the transition wall portion;
The rib can be attached to the bottom surface continuously or intermittently;
A rib can be provided for ornamental purposes and/or for functional purposes, such as for reinforcing the panel or for attaching to other components, etc (e.g. a door hinge, a handle, etc.);
The rib can be a wall segment of a panel stile (typically associated with side edges of a panel), or a panel rail, or a panel mullion (typically associated with center supports of a panel);
Functional openings can be configured on a wall segment of a panel stile; panel rail or panel mullion, for attaching thereto miscellaneous articles, such as door hinges for attaching the panel to a cupboard and the like;
At least a portion of the panel can be coated by an ornamental foil integrally embedded during the molding process;
The panel can comprise core injected portions, wherein the rib can constitute a wall portion of the core injected portion.

### BRIEF DESCRIPTION OF THE DRAWINGS

In order to understand the invention and to see how it can be carried out in practice, embodiments will now be described, by way of a non-limiting example only, with reference to the accompanying drawings, in which:

FIG. 1A is a front perspective view of a door panel in accordance with the disclosed subject matter;

FIG. 1B is similar to FIG. 1A, however with top and bottom rulers removed;

FIG. 2A is a back perspective view of the door panel of FIG. 1A;

FIG. 2B is a back perspective view of FIG. 1B;

FIG. 2C is an exploded back perspective view of a top portion of the door panel of FIG. 1A;

FIG. 2D is a front perspective exploded view of a top portion of the door panel of FIG. 1A;

FIG. 2E is a back perspective exploded view a bottom portion of the door panel of FIG. 1A;

FIG. 3A is a section along line III-III in FIG. 2;

FIG. 3B is an enlargement of the portion marked III in FIG. 3A;

FIG. 4A is a longitudinal section along line IV-IV in FIG. 2A;

FIG. 4B is an enlargement of the portion marked IV in FIG. 4A;

FIG. 5A is a front perspective view of a molding carriage useful in the process of molding a door panel in accordance with FIGS. 1 and 2;

FIG. 5B is a rear perspective view of the molding carriage of FIG. 5A;

FIG. 6A is a perspective sectioned view taken along line VI-VI in FIG. 5A;

FIG. 6B is an enlargement of the portion marked VI in FIG. 6A;

FIG. 7A is a sectioned perspective view taken along like VI-VI in FIG. 5A, however from a different angle;

FIG. 7B is an enlargement of the portion marked VII in FIG. 7A;

FIG. 7C is similar to FIG. 7B, however incrementally axially displaced;

FIG. 8A is a longitudinal section along line VII-VII in FIG. 5A;

FIG. 8B is an enlargement of the portion marked VIII in FIG. 8A;

FIG. 9A is a top perspective view of a molding table accommodating a molding carriage for molding a door panel in accordance with the present disclosed subject matter;

FIG. 9B is a planar section along line IX-IX in FIG. 9A;

FIG. 10 is a back perspective view of a door panel in accordance with a modification of the disclosed subject matter;

FIGS. 11A and 11B are illustrations of another embodiments of the transition wall portion connecting the panel and the ribs in accordance with the presently disclosed subject matter; and

FIGS. 12A-12B are illustrations of exemplary transition wall portions extending from the relative rib portions.

### DETAILED DESCRIPTION OF EMBODIMENTS

Presently disclosed subject matter with be exemplified using the following embodiments illustrated in the drawings.

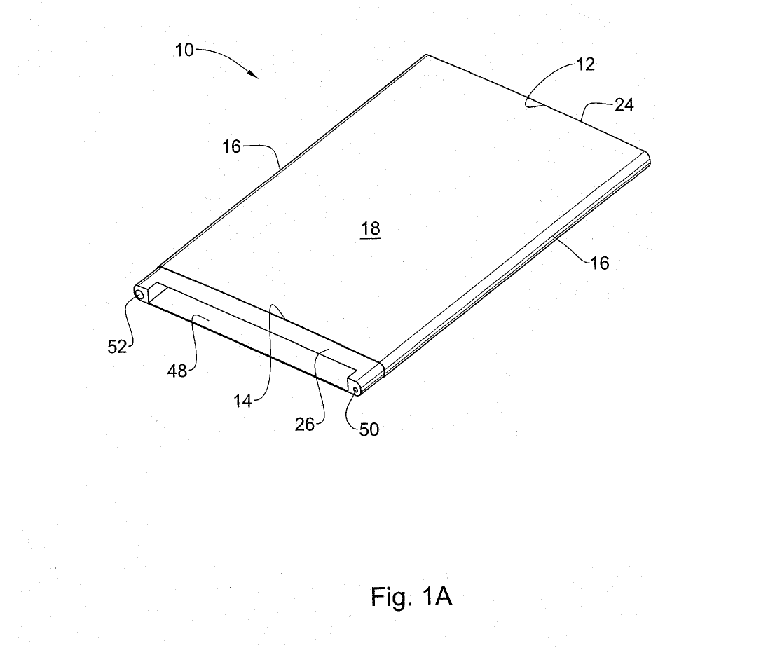

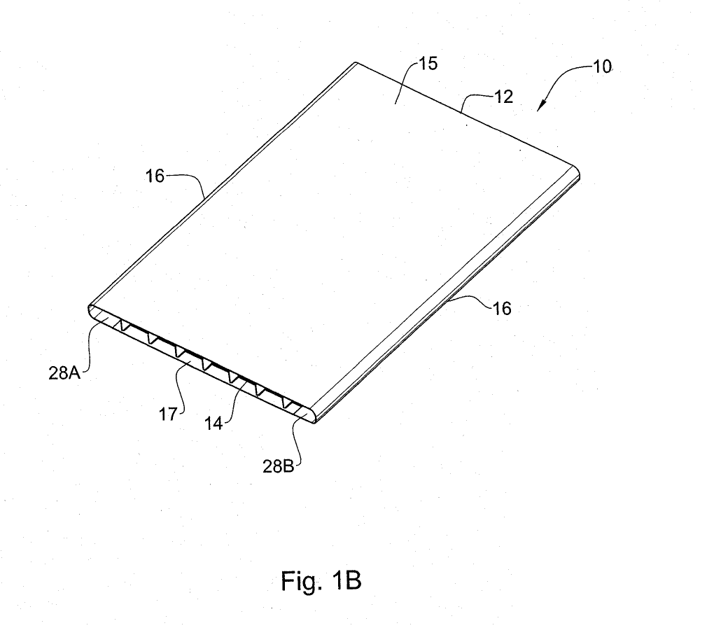

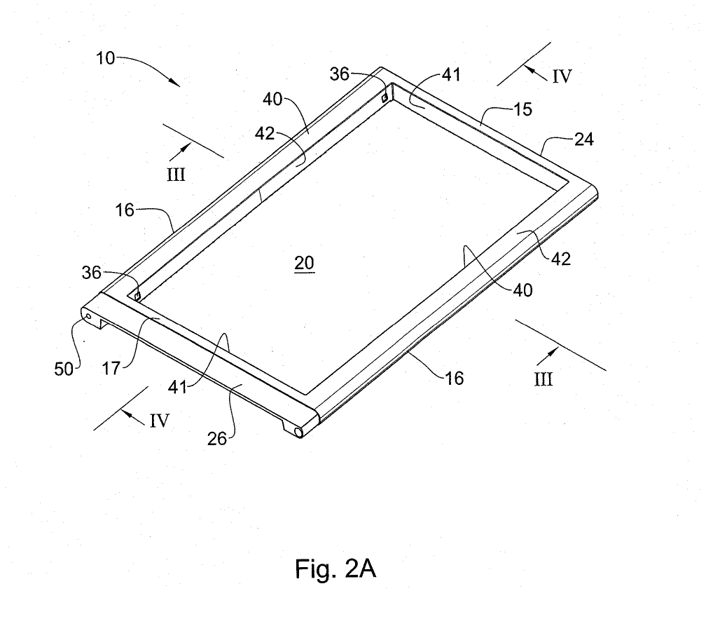

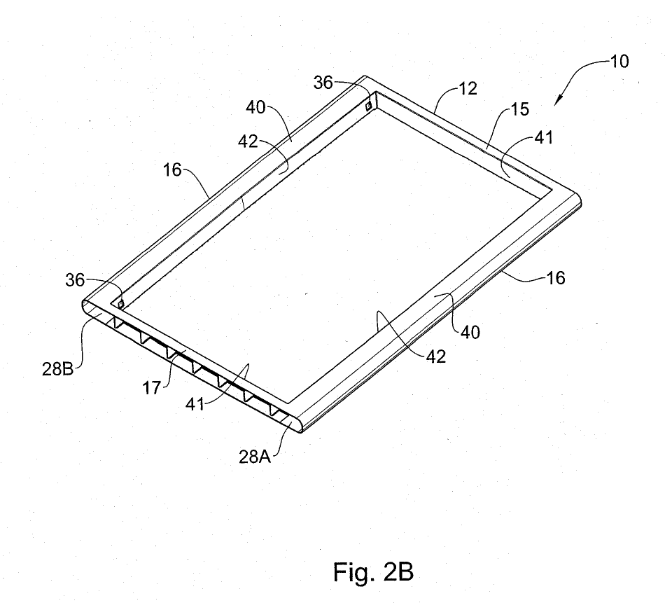

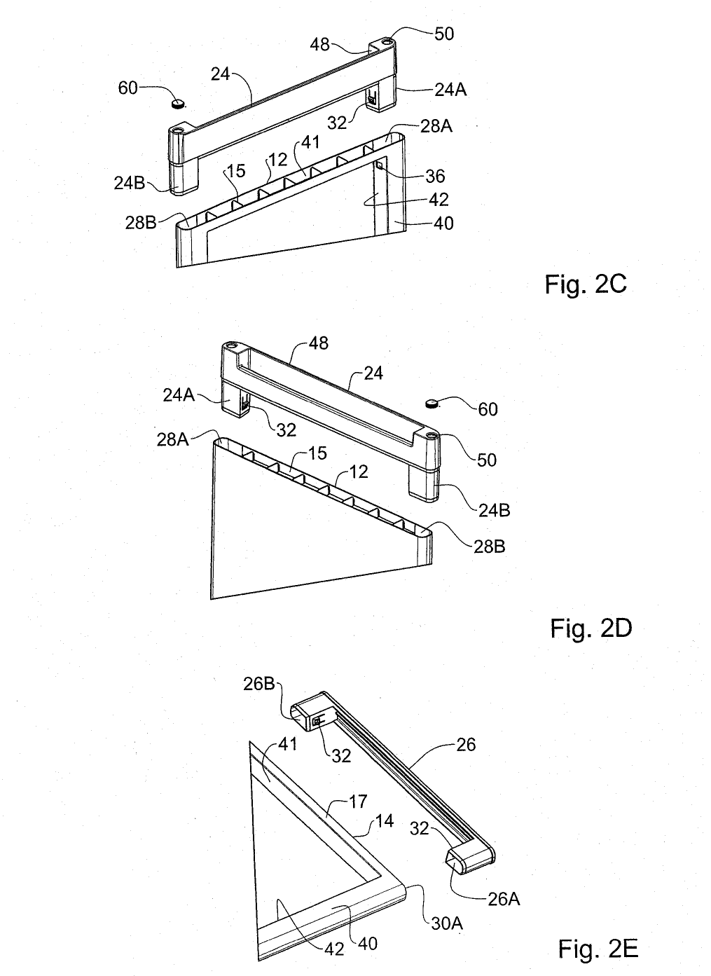

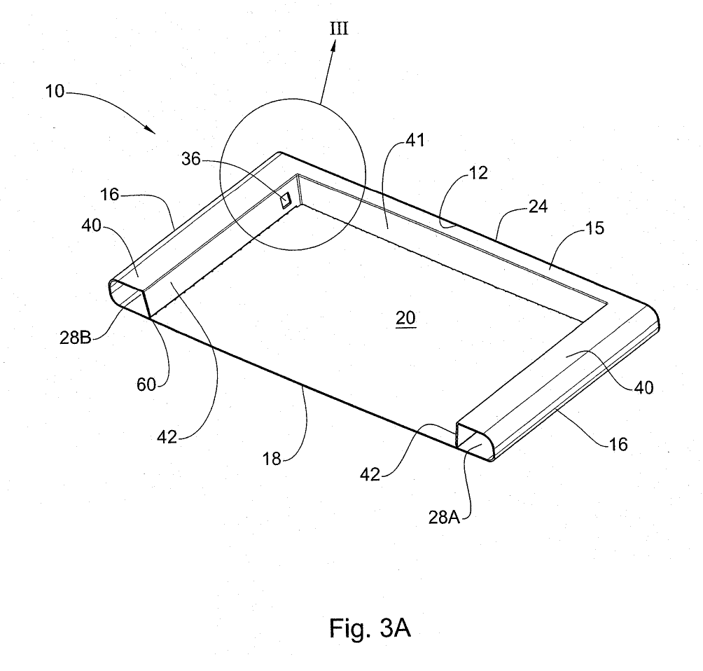

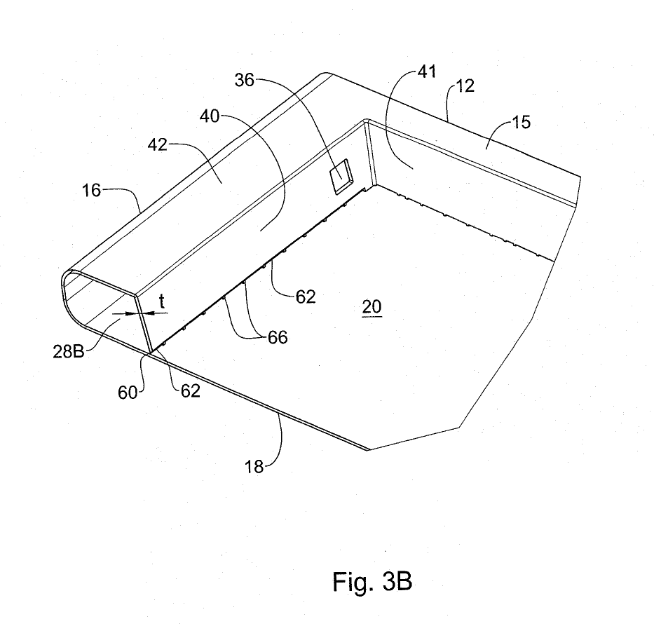

Attention is first directed to FIGS. 1 to 2 illustrating a door panel generally designated 10 manufactured in a plastic injection molding process as will be discussed hereinafter. Door panel 10 in accordance with the present example, serves as a door, e.g. for a kitchen cupboard and the like, though not limited thereto. It will be appreciated that the presently disclosed subject matter applies to other types of plastic articles and is not limited to door panels. Such articles can be any type of plastic article configured for house use, garden use, industry, machinery, automobiles etc.

The door panel longitudinally extends between a top edge 12 and a bottom edge 14 with two parallel side edges 16, defining a front surface 18 and a back surface 20 a top ruler 24 and a bottom ruler 26 are snappingly attached to the door panel through protrusions 24A and 24B configured for snugly receiving within corresponding apertures 28A and 28B formed along side edges of the door panel and likewise, the bottom ruler 26 is configured with projections 26A and 26B configured for snugly receiving within receptacles 30A and 30B (not seen) a bottom edge of the panel, wherein each of the projections 24A, 24B, 26A and 26B is fitted with a lateral projection 32 configured for snap engagement into an opening 36 formed at respective top and bottom edges of a rib 40, longitudinally extending and constituting an inner wall of a panel stile 42, integrally molded with the door panel 10, as will be discussed hereinafter in further detail.

It is further noted that the bottom ruler 26 is configured with a skirt portion 48 serving as a handle and further with an aperture 50, adjacent side edge 16, for mounting over a pivot hinge, and at an opposite side edge there is a bulge 52 serving for retaining the door at a closed position when mounted in a cupboard. However, the apertures 50 and bulge 52 can be concealed by a closure plug 60 (FIGS. 2C and 2D).

It is noted that the top ruler 24 and the bottom ruler 26 conceal openings at a top rail 15 and at bottom rail 17, respectively, of the door panel 10 and further imparted with sturdiness and rigidity.

With particular reference now being made to the top and bottom rails 15 and 17, and the longitudinal side stiles 42, it is noted that these are integrally molded with the panel 10 and comprise a rib (designated 40 in connection with the stiles 42 and designated 41 in connection with the top rail 15 and bottom rail 17) said ribs being integrally molded with the door panel 10 and extending from the back surface 20, said ribs 40 and 41 extending substantially upright from the back surface 20 and in the particular example extending parallel to the respective side edges 16 and top and bottom edges 12 and 14, respectively, of the door panel 10.

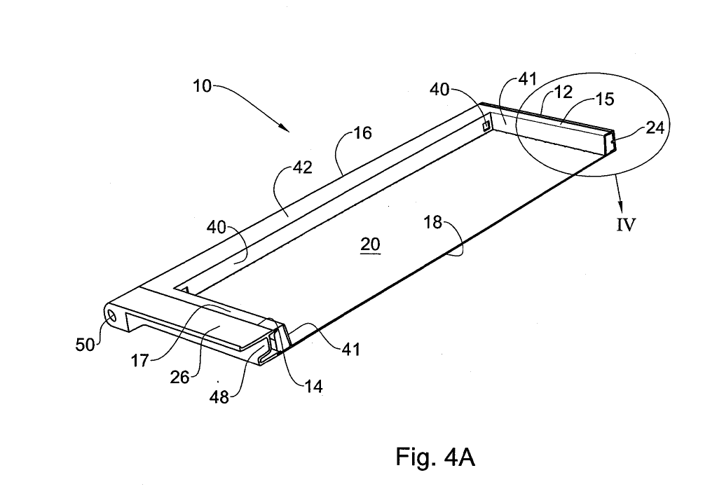

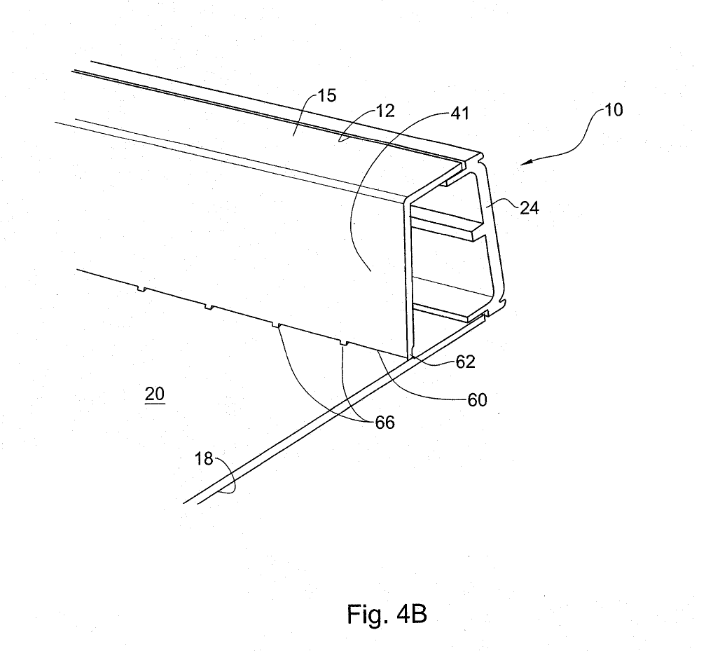

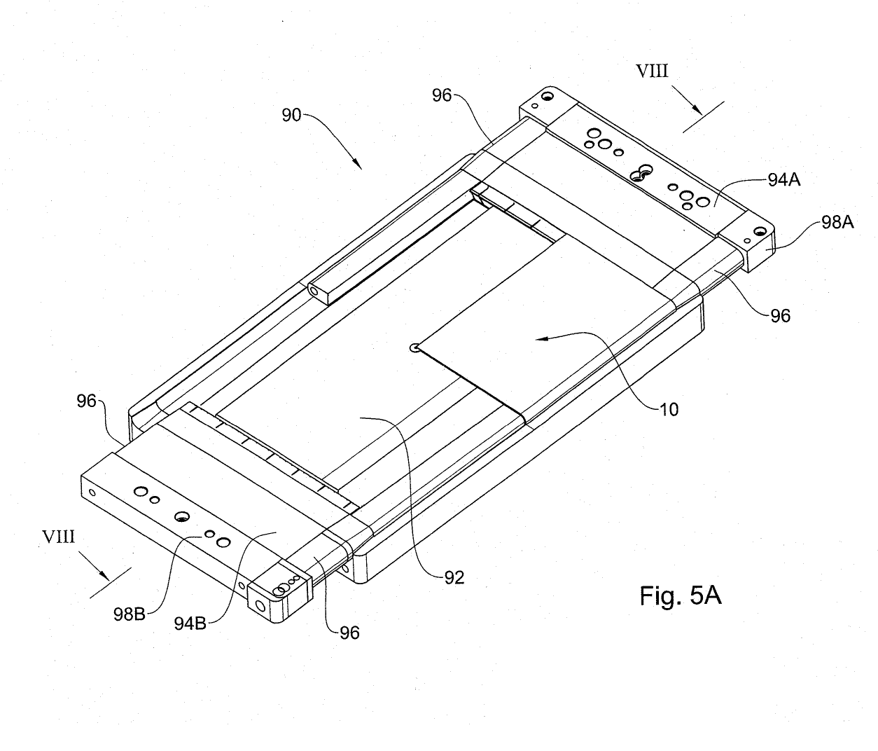

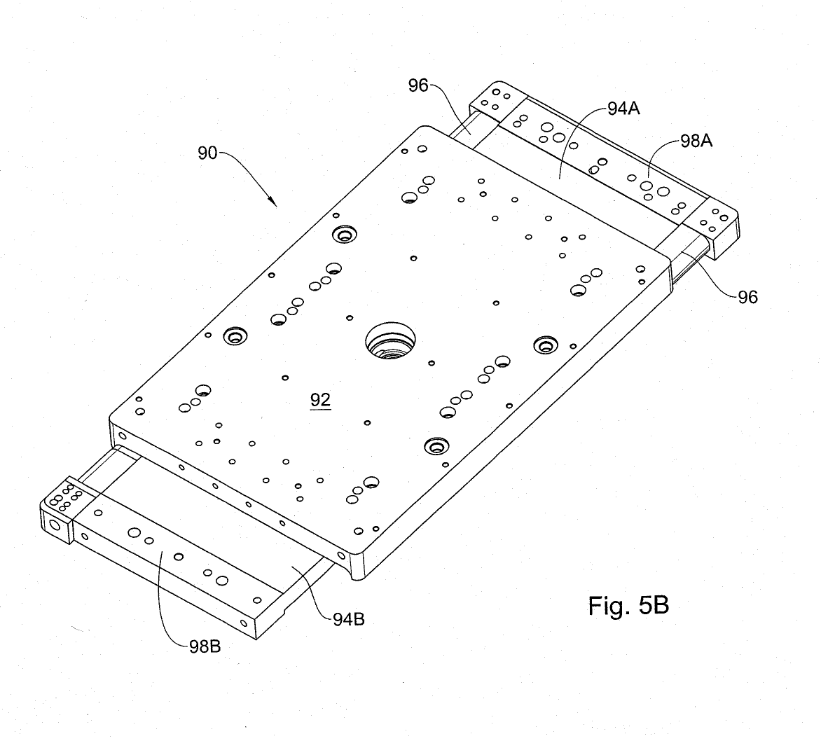

As can best be seen in the sectioned FIGS. 3A, 3B, 4A and 4B, the stiles 40 and the top rail 15 and bottom rail 17 are continuous and integrally molded as part of the panel 10 wherein the inner walls thereof namely ribs 41 and 42 intersect at right angles, thus imparting the panel 10 with rigidity. The ribs 41 and 42 integrally extend from the back surface 20 and as noted in FIGS. 1A and 1B the front surface 18 is substantially devoid of any sink marks giving rise to a smooth, eye pleasing surface. This is achieved by providing a transition wall portion 60 (best seen in FIGS. 3B and 4B) configured as a tapering section significantly thinner than the thickness key of the ribs 40 and 41 wherein a line of contact 62 is intermittently disturbed by a plurality of supports 66 extending at substantially equal intervals from one another, said supports 66 being slightly thicker than the overall thickness of the transition wall portion 60 at the tapering portions thereof 62. This arrangement provides on the one hand adequate flow of molten plastic material during the molding process to ensure uniform molding and yet, provides for a sufficiently rigid support rib and at the same time presents formation of any sink marks over the front surface 18 of the panel 10. The transition wall portion 60 has a thickness constituting 8-12% of the overall thickness of the panel 10 at least at the points of contact between the panel and the transition wall portion 60. In accordance with an example of the presently disclosed subject, the thickness of the transition wall portion is 10% of the thickness of the panel. The thickness of the rib is about ⅔ of the thickness of the panel.

However, it is noted that the recessions can extend at regular (equal) or irregular (unequal) intervals, and further, the depth of penetration can be equal or different along the path of the transition wall portion as described herein.

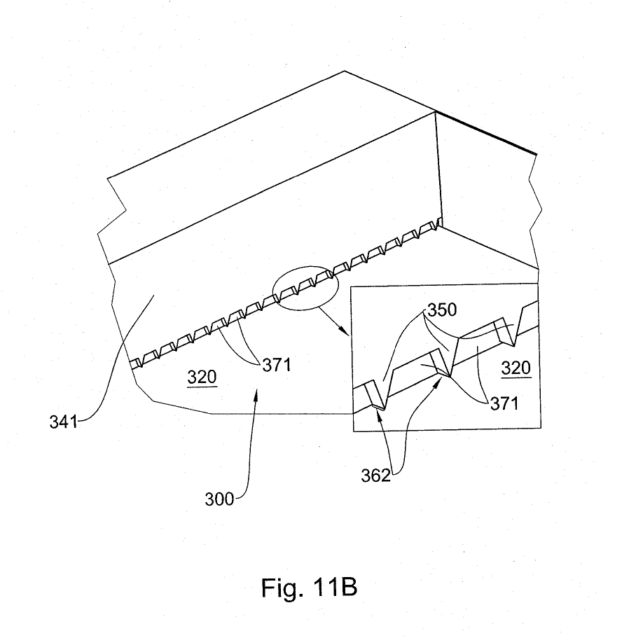

It is appreciated that whilst in the figures the ribs 40 and 41 extend substantially at a right angle with respect to the back surface 20 of the panel 10, the ribs can just as well extend at a slant, in either direction, whereby a so-called “undercut” requiring corresponding shaping of the mold, as will be discussed hereinafter. Furthermore, it is appreciated that the flat panel surface 20 extending between the side ribs 40 can be partitioned by further one or more support ribs (not shown), however formed in the same fashion, wherein such ribs can constitute part of reinforcing panel mullions (72 in FIG. 10 or stand along support ribs 74 in FIG. 10, wherein side walls 73 of mullion 72 and support ribs 74 are integrally formed with the back surface 76 of the panel 78 and extend from the back surface 76 in the same fashion as disclosed in connection with ribs 40 and 41 hereinabove extending through a transition wall portion significantly thinner than the thickness of a respective rib and the thickness of the panel.

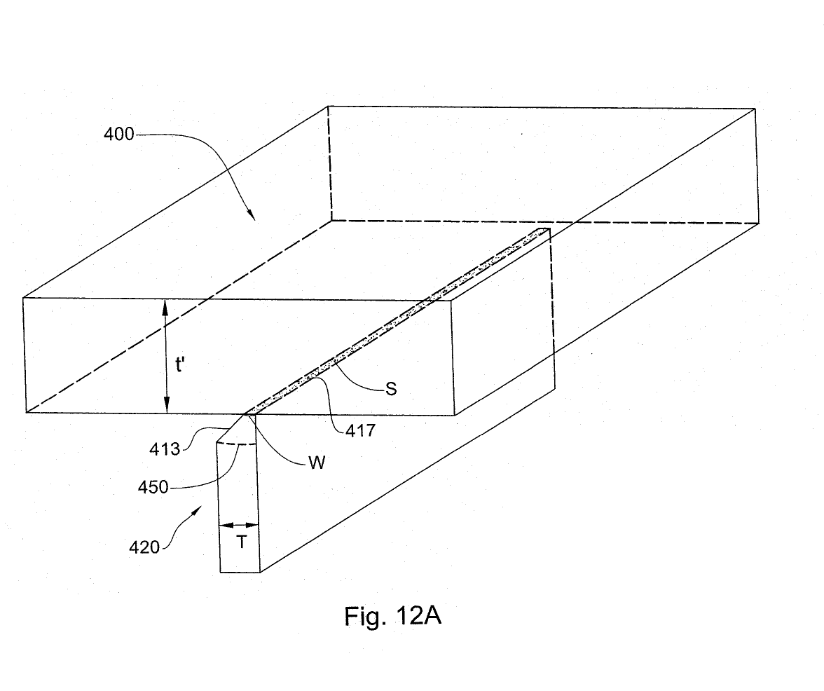

In accordance with yet an example of the presently disclosed subject matter (e.g. as seen in FIG. 11A), the transition wall portion is in the form of semi circular like elements 250 connecting the panel 200 at its back face 220 to the rib 241 through the undulating configuration. In accordance with this example of the presently disclosed subject matter, the area of contact 262 between the element 250 and the panel is of dimensions significantly smaller than the thickness of the panel 200 and constitutes about 10% of the thickness of the panel 200.

In accordance with the example illustrated in FIG. 11B, the transition wall portion is in the form of triangular elements 350 connecting the panel 300 at its back face 320 to the rib 341. In accordance with this example of the presently disclosed subject matter, the area of contact 362 between the element 350 and the panel is of dimensions significantly smaller than the thickness of the panel 300 and constitutes about 10% of the thickness of the panel 300.

It is further noticed that the transition wall portion comprises a thin film 371 connecting the bodies. The film is significantly thinner that the thickness of the transition wall portion elements. Such a film prevents for example fluid passage through the transition wall portion.

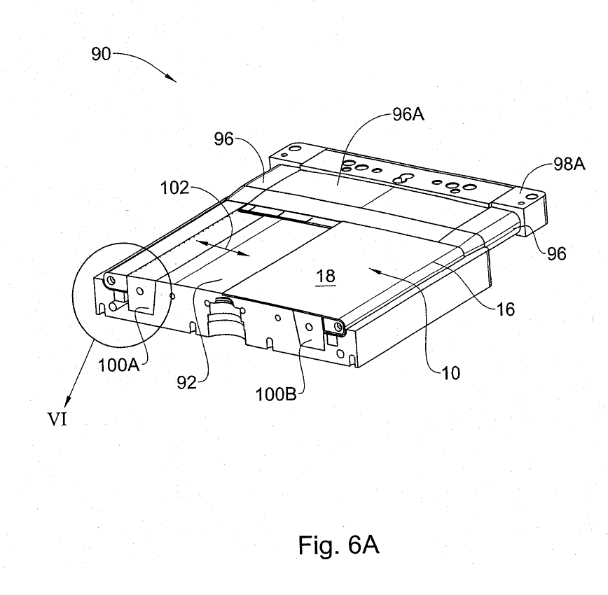

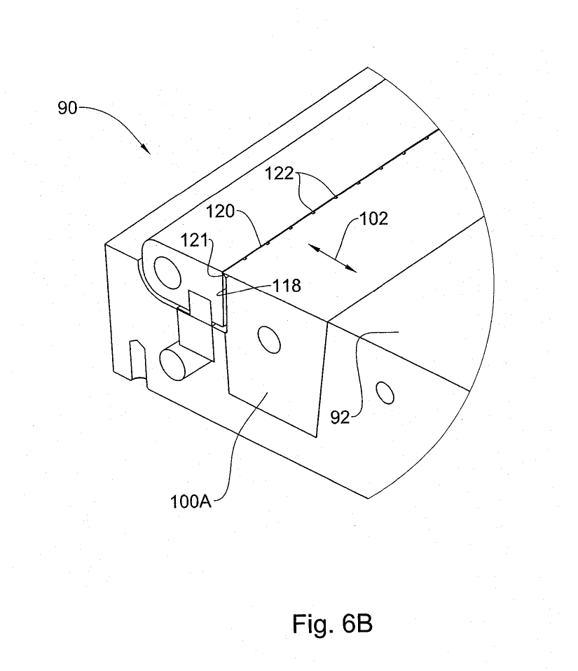

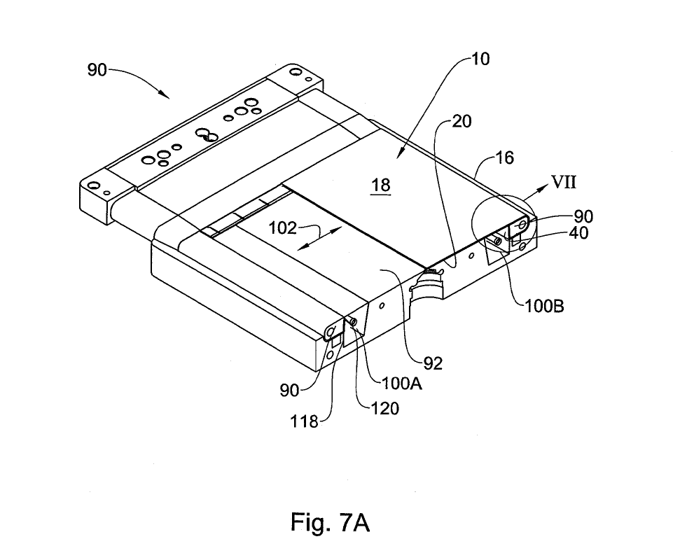

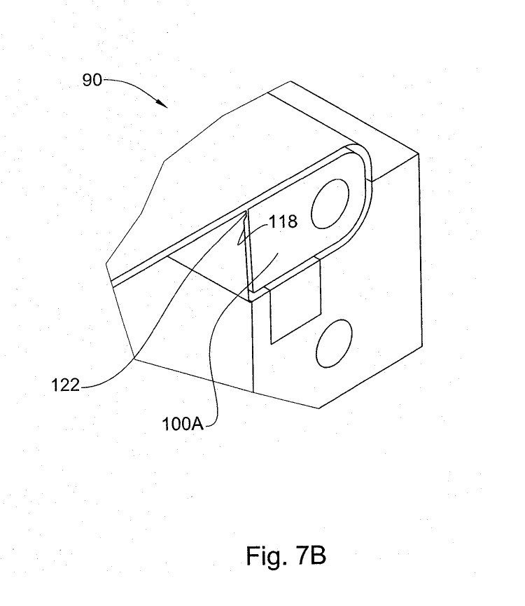

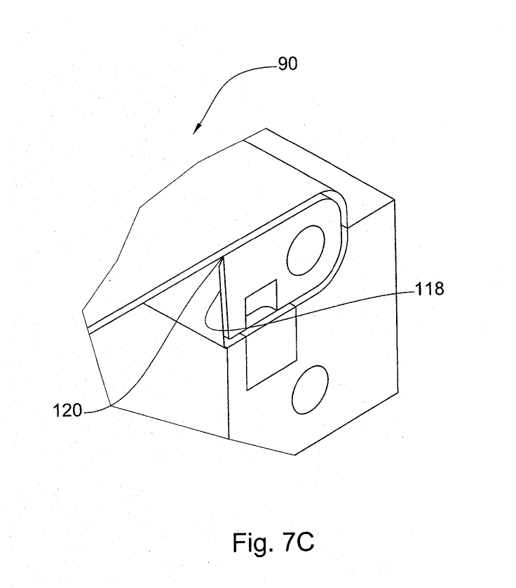

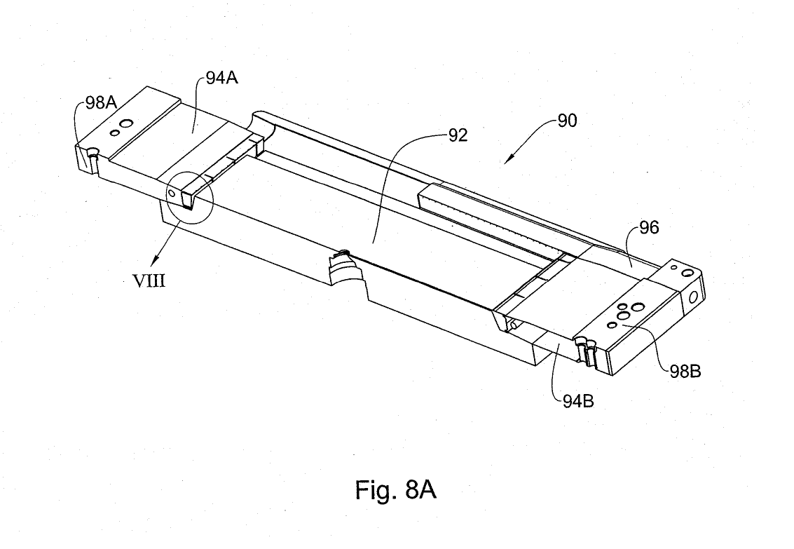

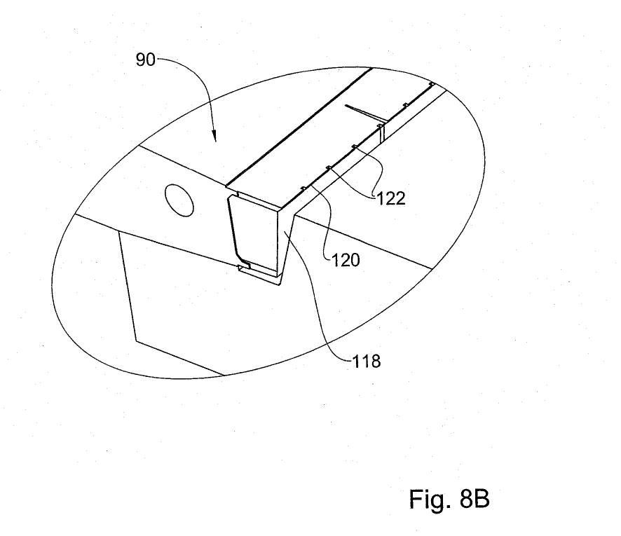

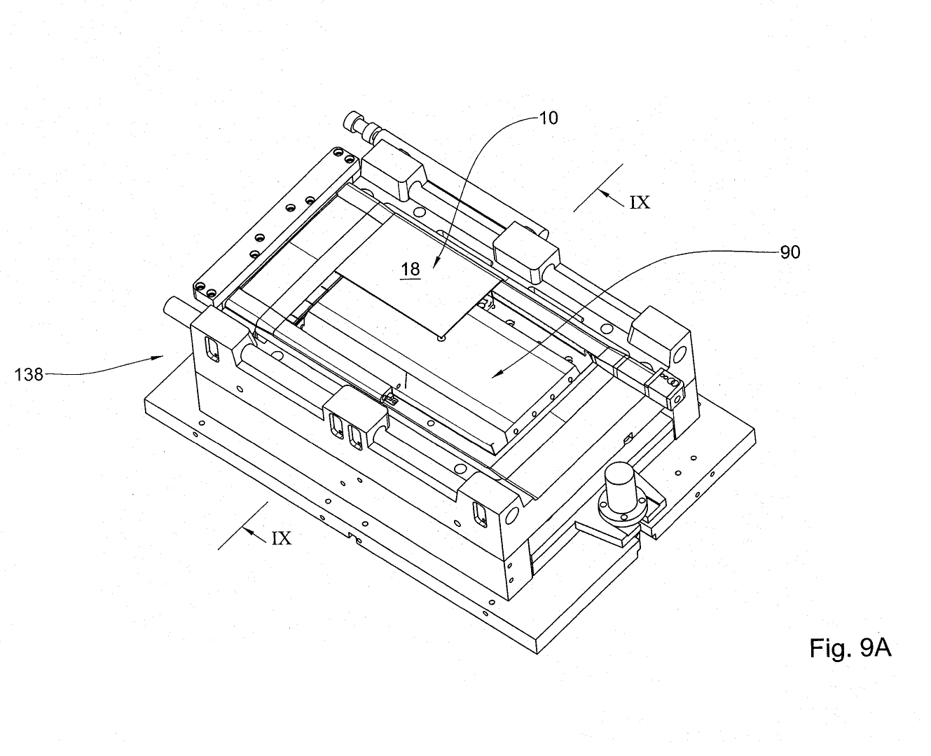

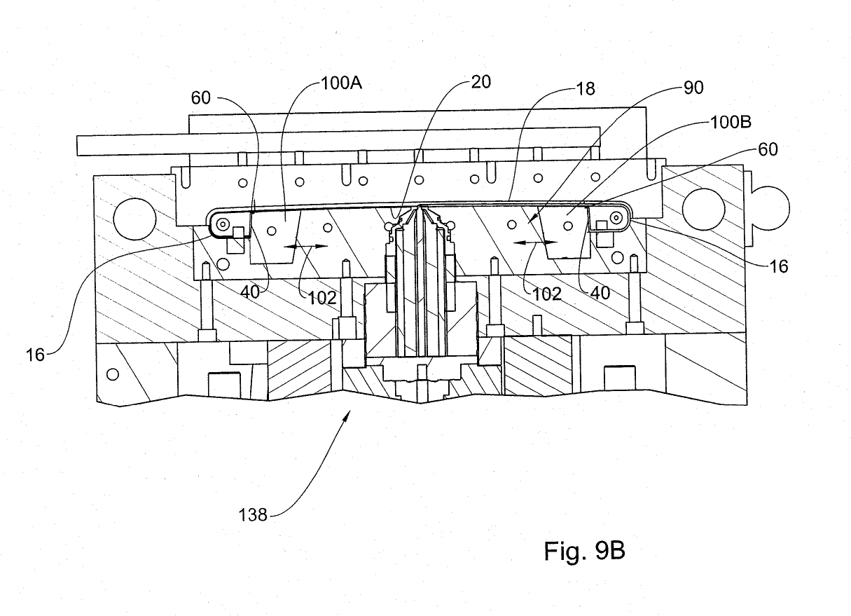

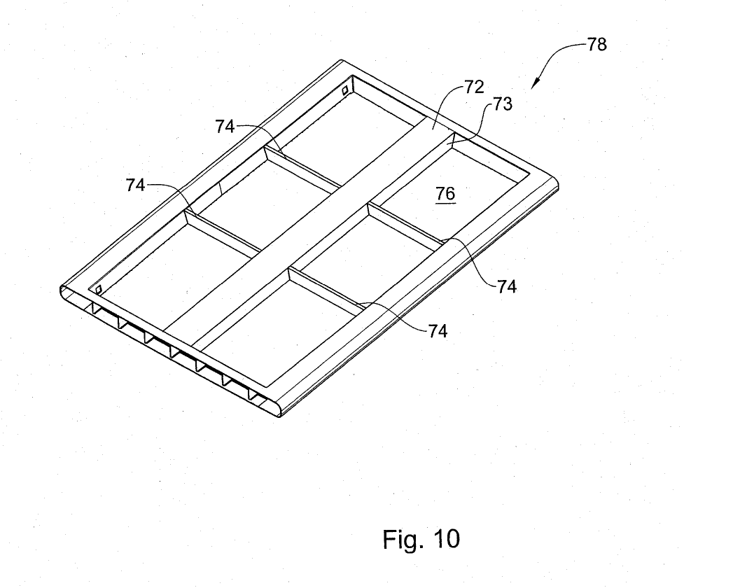

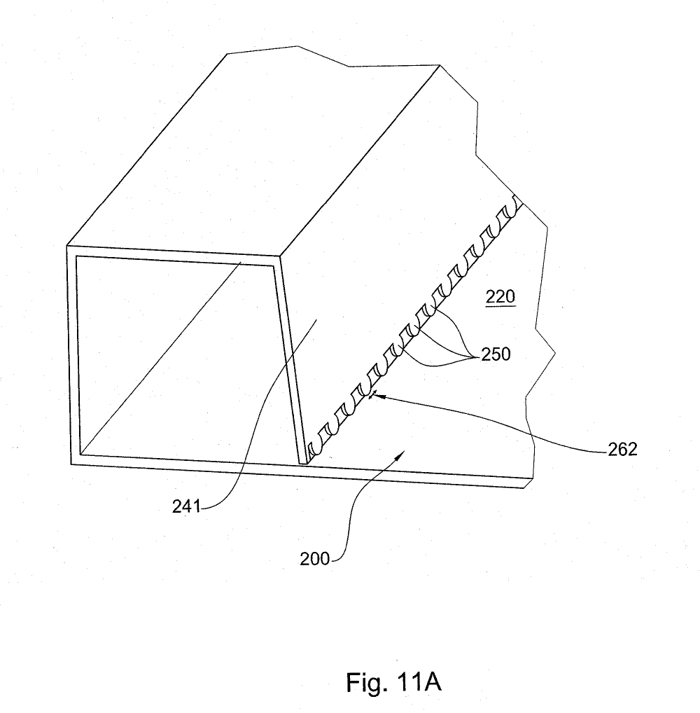

Further attention is now directed to FIGS. 5 to 8, directed to a molding carriage useful in a molding process of a panel in accordance with the present disclosed subject matter and further to FIGS. 9A and 9B illustrating a molding table configured with a molding carriage respectively.

The molding carriage generally designated 90 is configured for molding of a door panel 10 as disclosed in connection with FIGS. 1 to 4. The molding carriage 90 is configured as a core-mold carriage and comprises a top flat bed 92 and two axially slideable carriage members 94A and 94B each configured with core members 96 corresponding in shape with the shape of the panel stiles 42 and a top core portion 98A and a bottom core portion 98B corresponding in shape with the top rail 15 and bottom rail 17, respectively, of the door panel 10. The central bed 92 is configured with two laterally displaceable injection carriages 100A and 100B configured for lateral displacement in direction of arrowed line 102. As can be seen in the drawings, the sliding members 100A and 100B are configured with side walls 118 (corresponding with location of ribs 40 of the panel 10) and with a pointed edge 120 having a tapering transition wall 121 for creation of the position wall portion 60, said pointed wall 120 configured with a plurality of recessions 122 for creation plurality of supports extending at substantially equal intervals.

In the molding process, the molding carriage 90 is placed over a molding table 138 and is affixed thereto. Molten molding plastic material is introduced into the injection molding carriage via one or more ports evenly distributing the molten plastic material through appropriate cavities in the carriage 90 at substantially constant pressure and speed. Upon seizing of the injection process, the core slides 94A and 94B are axially extracted and the rulers 100A and 100B are retracted towards one another facilitating removal of the molded panel 10.

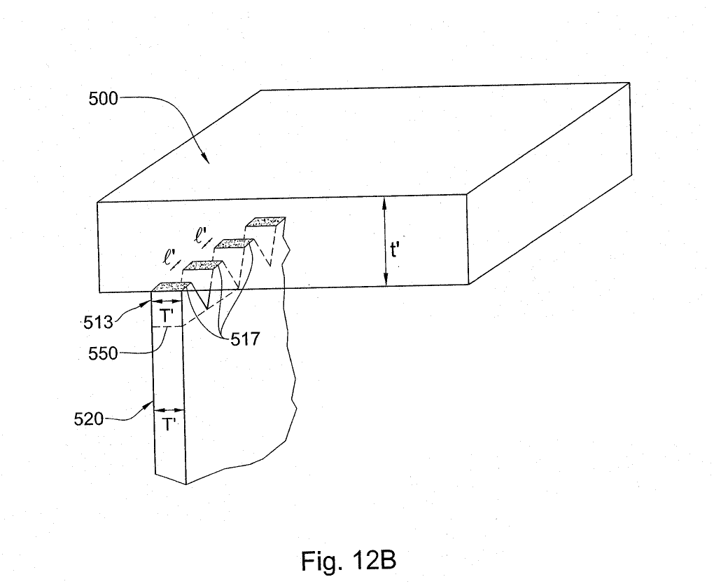

FIG. 12A schematically illustrates an enlarged portion of a transition wall portion 413 extending from a rib 420 and connected to the panel 400 in accordance with the disclosed subject matter. As can be seen, the area S of the contact surface 417 in contact with the panel 400 is significantly smaller than the cross sectional area of the rib 420 below the transition wall portion 413 (i.e. below the indicated by a broken line 450 location). As can further be seen, the width w of the transition wall portion is significantly smaller than the thickness t′ of the panel 400 and the thickness T of the rib 420. It will be appreciated that other configurations of the transition wall portion are possible, for example frusto-connical, frusto-pyramidal etc.

In FIG. 12B the transition wall portion 513 is an integral part of the rib 520 and is a non continuous, undulating structure of essentially trapezoid elements. The thickness of the transition portion 513 is the same as the thickness T′ of the rib 520. According to this example, the width l′ of each undulating element at the contact surface 517 with the panel 500 is significantly smaller than the thickness t′ of the panel and is thinner than the thickness T′ of the rib 520.

While there has been shown an embodiment of the disclosed subject matter, it is to be understood that many changes can be made therein without departing from the spirit of the invention mutandis mutatis.

For example, whilst the drawings and description make reference to a panel molded with core components, it is appreciated that the disclosed subject matter is concerned with any type of injection molding, not necessarily involving core-injection.

1. An injection molded panel configured with a front surface and a back surface, said back surface is configured with one or more ribs integrally extending from said back surface via a transition wall portion significantly thinner than the rib thickness and/or the panel thickness.

2. The injection molded panel according to claim 1, wherein an area of a contact surface between the transition wall portion and the panel is smaller than either the cross-sectional area of the rib below the transition wall portion and/or the width of the transition wall portion at the contact surface is smaller than the thickness of the panel.

3. The injection molded panel according to claim 1, wherein the transition wall portion tappers.

4. The injection molded panel according to claim 1, wherein the transition wall portion is a non-continuous structure constructed by undulating geometrical elements.

5. (canceled)

6. The injection molded panel according to claim 1, wherein the transition wall portion comprises a film of plastic material connecting elements constituting the transition wall portion.

7. The injection molded panel according to claim 1, wherein the one or more ribs can be attached to the back surface of the panel through intermittent transition wall portion elements, having a point of contact with the back surface of smaller dimensions than the thickness of the panel.

8. The injection molded panel according to claim 1, wherein the transition wall portion is constituted by triangular elements such that the point of contact between the back surface of the panel and an apex of the triangular elements is significantly smaller than the thickness of the panel.

9. A mold for injection molding of a panel, the mold configured with a sliding ruler displaceable about a plane and configured with a rib defining wall surface having a pointed ridge; said sliding ruler displaceable about a plane between a closed position in which the rib defining wall bears in close proximity with an opposite rib wall of the mold and defining together a rib thickness space, and an open position in which the ruler is spaced apart from the opposite rib wall, wherein at the closed position said pointed ridge extends closer to said opposite rib wall than the rib thickness.

10. A method for molding a panel configured with a front surface and a back surface, said back surface is configured with one or more ribs integrally extending from said back surface via a transition wall portion thinner than the rib thickness, the method comprising the following steps:
(a) obtaining a mold configured with a sliding ruler displaceable about a plane of the back surface and configured with a rib defining wall surface having a pointed ridge;
(b) placing the mold over a molding table;
(c) displacing the ruler into a closed position in which the rib defining wall bears in close proximity with an opposite rib wall of the mold and defining together a rib thickness space, wherein said pointed ridge extends closer to said opposite rib wall than the rib thickness;
(d) applying a molten material into the mold at substantially constant pressure and velocity;
(e) allowing the molded panel to cool;
(f) displacing the ruler into an open position in which the ruler is spaced apart from the opposite rib wall; and
(g) removing the molded panel.

11. The method according to claim 10, wherein before step c) injection cores are displaced into a closed position at a direction transversing the displacement of the rulers and after step e) said injection cores are displaced into their respective open position.

12. The injection molded panel according to claim 1, wherein the transition wall portion is a non-continuous, undulating structure of elements, and wherein the thickness of the transition wall portion is the same as the thickness of the rib and wherein the length of the contact surface of each undulating element associated with the panel is thinner than the thickness of the panel and/or is smaller than the thickness of the rib.

13. The injection molded panel according to claim 7, wherein the intermittent transition wall portion elements comprise spherical bead structures.
